(19) United States
(12) Patent Application Publication
(10) Pub. No.: US 2005/0114273 A1
(43) Pub. Date: May 26, 2005

(54) Systems and methods for affiliate utilization of online trading platform

(76) Inventor: Richard W. Ettinger JR., New Canaan, CT (US)

Correspondence Address: Basam E. Nabulsi;McCARTER & ENGLISH, LLP, Four Stamford Plaza, 107 Elm Street, Stamford, CT, 06902, US

(21) Appl. No.: 10/964,472

(22) Filed: Oct. 13, 2004

Related U.S. Application Data
(63) Continuation-in-part of application No. 10/831,947, filed on Apr. 26, 2004.
(63) Continuation-in-part of application No. 10/616,878, filed on Jul. 10, 2003.
(60) Provisional application No. 60/570,172, filed on May 12, 2004.

(51) Int. Cl. G06F 17/60

(52) U.S. Cl. 705/80; 705/26

(57) ABSTRACT

An automated system and method for displaying transactable items at multiple websites in real time. The system and method employs trigger criteria to identify appropriate transactable items for display at specific websites, e.g., affiliate websites. The system further facilitates receiving and responding to offer(s) based on predetermined criteria is disclosed. The automated system and method facilitates the sale of products/services over a computer network, e.g., the Internet or the World Wide Web. According to the disclosed system/method, an offer is electronically communicated to a processing system and, based on predetermined criteria, a responsive communication is electronically generated. The responsive communication generally takes the form of an acceptance of the offer, a counter-offer, or a communication regarding next steps in the negotiation process.

### 1. CROSS-REFERENCE TO RELATED APPLICATIONS

The present application is a continuation-in-part application that claims the benefit of: (i) a co-pending non-provisional patent application entitled “Automated Offer-Based Negotiation System and Method,” that was assigned Ser. No. 10/616,878 and was filed on Jul. 10, 2003, and (ii) a co-pending non-provisional application entitled “Automated Offer-Based Negotiation System and Method,” that was assigned Ser. No. 10/831,947 and was filed on Apr. 26, 2004. The present application also claims the benefit of a co-pending provisional patent application entitled “Systems and/or Methods Facilitating Effective Electronic Business Transactions,” that was assigned Ser. No. 60/570,172 and was filed on May 12, 2004. The entire contents of the foregoing non-provisional patent applications and provisional application are incorporated herein by reference.

### BACKGROUND OF THE DISCLOSURE

1. Field of the Disclosure

The present disclosure relates generally to an automated system and method for receiving and responding to offer(s) based on predetermined criteria and, more particularly, to an automated system and method for the sale of products/services over a computer network, e.g., the Internet or the World Wide Web. The present disclosure is further directed to an automated system and method for establishing an electronic online marketplace and facilitating access, display and/or operation of such electronic online marketplace at one or more distinct websites, e.g., affiliate sites. Advantageous automated systems and methods according to the present disclosure are configured and designed to process an offer that is electronically communicated to a processing system through interaction with one of a plurality of websites and, based on predetermined criteria, a responsive communication is electronically generated, such responsive communication generally taking the form of an acceptance of the offer, a counter-offer, and/or a communication regarding next steps in the disclosed negotiation process.

2. Discussion of Background Art

Negotiations are fundamental to countless business transactions. Numerous issues can come into play in negotiating the purchase and/or sale of goods or services, e.g., price, quality, quantity, delivery time, warranties, etc. Individuals involved in negotiating transactions often develop specialized knowledge and experience that assist them in conducting successful negotiations, i.e., negotiations of transactions wherein the terms/conditions are favorable and/or desirable.

Not all transactions are subject to negotiation. For example, typical retail purchases are generally based on fixed prices that are either accepted or rejected by a prospective purchaser. In certain instances, a price benefit may be achieved by purchasing multiple items (e.g., three items for a dollar), or by purchasing in greater bulk. In addition, cost savings may be achieved through coupons, periodic “sales prices” and/or member/frequent customer discounts.

With the advent of widespread networked communication systems, transactions are frequently undertaken through computer-based systems, e.g., over the Internet or the World Wide Web. Countless websites may be accessed that permit goods and/or services to be viewed and evaluated for potential purchase. Many websites facilitate the purchase of goods and/or services, generally at a price that is set forth at the website. Negotiation of terms, including price, is generally not possible when purchasing goods/services over the Internet.

Beyond the more traditional websites discussed above, some websites support the sale/purchase of goods and/or services at prices that may vary from time-to-time and from user-to-user. Thus, for example, certain “auction sites” permit multiple individuals to “bid” on an item, e.g., a product or service, for a preset period of time. The individual that bids the highest price is generally successful in acquiring the item. Auction sites thus function as an electronic marketplace where buyers are able to view and bid on goods/services made available by participating sellers. A market leader in the field of web-based auction sites is “eBay” (www.ebay.com).

Other websites permit an individual to submit an “offer” for the purchase of goods and/or services, and such offer is either accepted or rejected based on criteria associated with design/operation of the website. For example, the “Priceline” website (www.priceline.com) permits individuals to submit offers for hotels, airfares and the like. However, the “Priceline” site does not permit a potential purchaser to delineate all relevant parameters surrounding the desired goods/services, e.g., the precise hotel or precise air travel itinerary of interest. Moreover, websites like the “Priceline” site are unable to generate and/or communicate counter-offer(s) in response to offers that are deemed unacceptable.

While some Internet sites have developed an ability to display their advertiser's ads to appear on other websites, e.g., affiliate sites, the displayed ads are of limited functionality. Thus, for example, the displayed ads generally permit an Internet user to link to another website that provides additional information concerning the advertised item and/or offers the advertised item for sale. While advertising-related links are desirable from an advertiser's standpoint, currently available systems and functionalities are of limited value in leveraging the significant investment associated with developing and hosting electronic online marketplaces.

Thus, despite efforts to date, a need remains for an automated system and/or method for supporting negotiations involving goods and/or services that may be accessed from a plurality of websites in real time. Moreover, a need remains for an electronic online marketplace that is configured to receive and respond to offer(s) based on predetermined criteria, such marketplace being adapted for simultaneous access, viewing and interactive manipulation, in whole or in part, at a plurality of websites. In addition, a need remains for transaction systems/methods that facilitate the automated evaluation of electronic offer(s) received from one or more of a plurality of websites and to formulate/communicate an appropriate response (e.g., a counter-offer, acceptance and/or communication regarding the continuation of negotiations) to the user at such website based on predetermined criteria. Exemplary embodiments of the system and method of the present disclosure satisfy the foregoing needs, as described below.

### SUMMARY OF THE DISCLOSURE

The present disclosure is directed to an electronic system and method that facilitates automated, real-time negotiations based on communications with users of one or more distinct websites. The disclosed system/method may be operated on any computer network, e.g., an intranet, extranet, wireless network, the Internet, the World Wide Web, and other networked computer systems. The disclosed system includes at least one server and/or processor that is programmed to evaluate an offer based on predetermined criteria, e.g., calculations that permit offer assessment based on predetermined factors and/or variables. Exemplary embodiments of the disclosed system/method advantageously permit the sale/purchase of goods and/or services at prices that provide beneficial weight to predetermined aspects of the offer, e.g., aspects that influence the variable cost to the seller, i.e., price and quantity.

The server and/or processor that is programmed to evaluate offers as described herein is advantageously configured and adapted for communication with web-based users that access offer(s) at one of a plurality of websites that are linked to the electronic online marketplace of the present disclosure. According to exemplary embodiments of the present disclosure, a plurality of websites are linked to the server(s)/processor(s) that operate an electronic online marketplace for real time interaction therewith. The disclosed system and method thus permits an operator of an electronic online marketplace to leverage its operations by providing access, in whole or in part, to the goods and/or services offered for sale at such marketplace for simultaneous access from multiple websites (e.g., a website hosted by the operator and at least one additional website).

The displayed listings facilitate transactional interaction by a website user and advantageously support or link with underlying inventory management functionality, multiple selling methodologies and/or a limited life offer for the listed item. The foregoing functionalities and associated operational parameters are generally set up by the seller, e.g., based upon selection from among predetermined criteria made available by the operator of the underlying electronic online marketplace. Typically, the posted listings link to goods or services that are individually listed on the underlying electronic online marketplace for immediate transactability.

According to an exemplary embodiment, when a user/customer lists an item for sale on or at a first electronic online marketplace site, he/she will have the ability to select an option to have his/her item appear on other site(s) for a specific fee. Exemplary pricing modalities include “cost-per-click,” a one time fixed price, a commission share/percentage if an item sells, or a combination thereof. Generally, when entering the listing, the customer/user associates certain criteria with the item, e.g., specific product/service categories, keywords, and the like. These specific criteria are advantageously employed by the disclosed system/method in determining the affiliated websites at which the listing will be displayed. Additional factors or parameters, i.e., “triggers,” that generally impact upon the display of such listing at affiliated site(s) include payment terms (e.g., the relative value associated with potential sale of the listed item at the associated site), offer time/date, offer termination time/date, and the like.

To implement the disclosed system/method, a website that desires to access and display items (i.e., goods or services) that are available for purchase at a distinct electronic marketplace (i.e., the “underlying electronic marketplace”) generally installs an appropriate module of code that communicates with the code operating such underlying electronic marketplace. The module of code is adapted to communicate with the server/processor that supports operation of the underlying electronic online marketplace to access, display and communicate offers/responses associated with the listed item(s). The communications between the module and the server/processor are advantageously accomplished in real time, thereby facilitating the delivery of items for sale/purchase that satisfy applicable triggers and/or trigger criteria, e.g., items having a limited life span for sale.

According to exemplary embodiments of the present disclosure, potentially affiliated websites are provided with a level of control over the items to be displayed for sale at their websites according to the present disclosure. For example, in implementing the disclosed system/method, an affiliated website may be provided with one or more options for choosing the types of items to be displayed for sale at its site. The affiliated website is further generally provided with the ability to alter and/or modify its choices from time-to-time, thereby permitting strategic and/or tactical adjustments, as needed or desired. Through selection of specific trigger criteria, an affiliate is generally permitted to define a desired class of goods/services for display at its website, e.g., based on selection of one or more specific product/service categories, selection of one or more specific keywords, and/or selection of “spider” functionality whereby appropriately related goods/services may be selected for display based upon an audit/assessment of the underlying electronic marketplace's website content. According to exemplary spider functionality of the present disclosure, appropriate keywords and/or categories may be utilized based upon an audit/assessment of an affiliate website's content, theme or market positioning.

According to exemplary embodiments of the disclosed system/method, automated offer-based negotiation functionality may be advantageously employed in conjunction with the display of goods/services at one or more affiliated websites. Applicant has previously disclosed advantageous automated offer-based negotiation systems in previously filed non-provisional applications (“Automated Offer-Based Negotiation System and Method,” Ser. No. 10/616,878, and “Automated Offer-Based Negotiation System and Method,” Ser. No. 10/831,947). The subject matter of the foregoing non-provisional applications is incorporated herein by reference.

Thus, according to exemplary offer-based negotiation functionality, an offer for goods and/or services is electronically communicated or transmitted across a network. The offer generally includes certain predetermined purchase terms, e.g., price and quantity. The offer is generally routed to and received at a server/processor, and is evaluated against predetermined criteria that are stored at such server/processor, e.g., in storage or memory associated with the server/processor. If the electronically transmitted offer satisfies the predetermined criteria, the offer is automatically accepted by the system/method, and such acceptance is electronically communicated/transmitted to the source of the offer across the network. If the offer does not satisfy the predetermined criteria, e.g., if the price is too low based on the proposed quantity to be purchased, the disclosed system/method automatically: (i) generates a counter offer or counter offers based on the predetermined criteria and transmits such counter offer or counter offers to the source of the original offer, and/or (ii) generates a communication concerning next steps in negotiations with the source of the offer, e.g., if the number of unacceptable offers exceeds a predetermined threshold the source of the offer may be advised as to the applicable waiting period before an additional offer will be processed, and/or (iii) generates a “buy now” offer price for the item of interest. Of note, the counter offer or counter offers may include one or more options for consideration by the source of the initial offer, e.g., based on multiple price/quantity combinations and a “buy now” pricing option.

If the source of the original offer finds a counteroffer acceptable, such individual communicates his/her acceptance across the network to the server/processor and the transaction is completed through conventional means, e.g., credit card purchase, products and/or service delivery, and the like. Thus, the disclosed system/method of the present disclosure offers advantageous, automated negotiation functionalities that permit an offer to be received, evaluated, accepted “as-is”, countered by way of one or more counter offers, or rejected with a communication as to next steps/time frames for continuation/resumption of the negotiations. Electronic communications are generally logged in conventional memory systems associated with the disclosed method/system, and further communication modalities are generally provided to support ancillary functions, e.g., credit checks, fulfillment functions and the like.

Exemplary embodiments of the disclosed system/method permit a system user, e.g., an administrator, to input desired predetermined criteria for use in automatically evaluating and responding to offers received at the disclosed server/processor. In addition, non-administrative individuals may post offered item(s) on the disclosed system, thereby making such item(s) available for negotiation and potential sale, as disclosed herein. Predetermined criteria for use in automatically evaluating and responding to offers for such item(s) may be input by such administrative or non-administrative users and/or may be implemented based on criteria associated with the disclosed system/method, e.g., pre-loaded algorithmic systems maintained within computer memory associated with the disclosed system/method.

One or more algorithmic systems for formulating acceptance criteria and/or generating counter-offers may be stored within memory storage associated with the disclosed system/method. The algorithmic systems may advantageously draw on real-time data in formulating acceptance criteria or generating counter-offers, e.g., current inventory levels, current promotional initiatives, etc. Thus, the formulation of acceptance criteria and/or generation of counteroffers is generally a dynamic functionality, rather than a static functionality based on pre-set and non-dynamic parameters. The administrative and/or non-administrative personnel involved in selecting desired system(s) for formulating acceptance criteria and generating counteroffers may select from available algorithmic systems and/or may input, in whole or in part, desired algorithmic system(s) for use with respect to his/her item(s).

The predetermined criteria that generally influence the formulation of acceptance criteria and generation of counteroffers may vary from time-to-time, e.g., based on marketing/sales initiatives, variations in product/service inventory, and other factors influencing or driving pricing/sales approaches. Of note, the counteroffer generated in response to a first offer may not be the same as the counteroffer generated in response to a second, but identical offer, that is subsequently received by the disclosed server/processor, based on a randomizing factor associated with the predetermined criteria disclosed herein.

According to exemplary embodiments of the disclosed system/method, operation of programming associated with the disclosed server/processor advantageously generates multiple different counter offers for transmission to the source of the offer, thereby providing such individual with multiple choices for consideration and increasing the likelihood that at least one counter offer will be acceptable to such individual. Thus, the multiple counter offers may be based on (1) accepting the offered price, provided a specified (greater) number of units (goods or services) are purchased, (2) offering a different (higher) price based on the number of units (goods or services) specified in the original offer, or (3) offering a price at which the individual may purchase the product or service immediately, without any further offers or counter offers. Additionally, the disclosed system/method may include criteria governing required modes of interaction with the system. For example, the disclosed system/method may automatically set time and/or navigational criteria for continued negotiations, e.g., the source of the offer must respond within “x” minutes without navigating to another website, thereby increasing the impetus for the individual to reach a purchase agreement pursuant to the disclosed system/method. The disclosed system/method may also advantageously restrict an individual's ability to submit a new/revised offer for a period of time (i.e., a pre-set “wait period”). For example, an individual would be prevented from submitting/transmitting further offers (either for the same products/services or for any products/services) for a predetermined period of time once “x” number of offers/counteroffers have been exchanged by the system and such individual with respect to a product/service.

Thus, the disclosed system and method advantageously offers the ability for the sellers of an item to utilize multiple selling methodologies, e.g., with a limited duration, whereby a transactable listing appears on a plurality of websites, e.g., affiliate partner sites, with real time statistics, e.g., time remaining, quantity remaining, available selling/purchasing methodologies, current and/or last price, product photograph and/or product description. The disclosed system and method also offer the ability to link back to a transaction page for the displayed item on a host/originating electronic online marketplace. The disclosed system and method may be advantageously employed with offer-based negotiation functionality, as described herein, but the present disclosure is not limited to such implementations.

Additional advantageous features and functionalities of the disclosed system/method will be apparent to persons skilled in the art from the detailed description, appended drawings and claims which follow.

### BRIEF DESCRIPTION OF THE DRAWINGS

So that those of ordinary skill in the art to which the subject disclosure pertains will more readily understand how to design and use the system and method of the present disclosure, exemplary embodiments will be described with reference to the drawings appended hereto, wherein:

FIG. 1 is block diagram that schematically illustrates certain electronic communications associated with the exemplary embodiments of the disclosed system and method;

FIG. 1A is a further block diagram that schematically illustrates certain electronic communications associated with an exemplary embodiment of the disclosed system and method wherein a plurality of websites display items for sale;

FIG. 2 is a further block diagram that schematically illustrates a series of steps associated with price-based negotiations according to exemplary embodiments of the present disclosure; and

FIGS. 3 to 17 are screen shots derived from Internet-based examples of the disclosed system and method.

### DESCRIPTION OF EXEMPLARY EMBODIMENT(S)

The present disclosure generally provides an automated system and method for communication with web-based users that access item(s)/offer(s) at one of a plurality of websites. The item(s)/offer(s) are generally associated with an electronic online marketplace and may be associated with applicable categories, keywords and the like. A plurality of websites are generally linked to the server(s)/processor(s) that operate the underlying electronic online marketplace for real time interaction therewith. The disclosed system and method thus permits an operator of an electronic online marketplace to leverage its operations by providing access, in whole or in part, to the goods and/or services offered for sale at such marketplace for simultaneous purchase by users accessing such goods/services from multiple websites.

To implement the disclosed system/method, a website that desires to access and display items (i.e., goods or services) that are available for purchase/sale at an underlying electronic online marketplace installs appropriate software, e.g., a module of code, that is adapted to communicate with the application that supports transactions with respect to the items. The software generally communicates with the server/processor that supports operation of the underlying electronic online marketplace, i.e., over a network (e.g., the Internet), to access, display and communicate offers/responses associated with the listed items. The communications between the module and the server/processor are accomplished in real time, thereby facilitating the delivery of items for sale that satisfy applicable triggers and/or trigger criteria, e.g., items having a limited life span for sale.

Websites seeking to participate in the disclosed system/method are generally provided with a level of control over the items to be displayed for sale at their websites. For example, in implementing the disclosed system/method, a website is typically provided with one or more options for choosing the types of items to be offered at its site. The website is further generally provided with the ability to alter and/or modify its choices from time-to-time, thereby permitting strategic and/or tactical adjustments, as needed or desired. Through selection of specific trigger criteria, a participating website is generally permitted to define a desired class of goods/services for display at its website, e.g., based on selection of one or more specific product/service categories, selection of one or more specific keywords, and/or selection of “spider” functionality whereby appropriately related goods/services may be selected for display based upon an audit/assessment of the underlying electronic online marketplace's website content. As will be apparent to persons skilled in the art, spider functionality may be employed such that appropriate keywords and/or categories are identified based upon an audit/assessment of an affiliate website's content, theme or market positioning, and such keywords/categories may then be employed to select appropriate goods/services for display at the website.

The displayed listings permit transactional interaction by a website user, thereby permitting the website user to enter into transactions with respect to a listing/offer from multiple participating websites. The underlying transactional engine advantageously supports or links with inventory management functionality, multiple selling methodologies and/or a limited life offer for the listed item. According to preferred embodiments of the present disclosure, transactions may be undertaken according to a plurality of offer-based negotiation modalities.

For example, according to an exemplary offer-based negotiation modality, the disclosed system is configured to receive and respond to offer(s) based on predetermined criteria. An offer is electronically communicated to a processing system across the computerized network from one of a plurality of participating websites and, based on predetermined criteria, a responsive communication is electronically generated at a disclosed server/processor in real-time. The responsive communication generally takes the form of an acceptance of the offer, a counter-offer and/or a communication as to next steps/time frames for continuation/resumption of the negotiation process.

The disclosed system/method advantageously automates a negotiation regimen, in real-time, and such negotiation regimen may be accessed from multiple participating websites. Upon receipt of an electronically communicated offer, the offer is automatically evaluated against predetermined acceptance criteria for offer acceptance and, to the extent the offer does not satisfy such predetermined acceptance criteria, a counter offer may be formulated and communicated to the source of the original offer. According to exemplary embodiments, the counter offer may advantageously include a plurality of price/quantity combinations. In such circumstance, each of the price/quantity combinations is generated at the server/processor based on predetermined criteria and, preferably, generated using a randomizing factor. In any event, each of the combinations reflects a business proposition that is desirable/acceptable to the seller based on the predetermined criteria that are supplied to, and operated by, the disclosed server/processor. By providing multiple price/quantity combinations in the automated counter offer, the system/method of the present disclosure increases the likelihood that a transaction will be successfully consummated between the source and recipient of the initial offer.

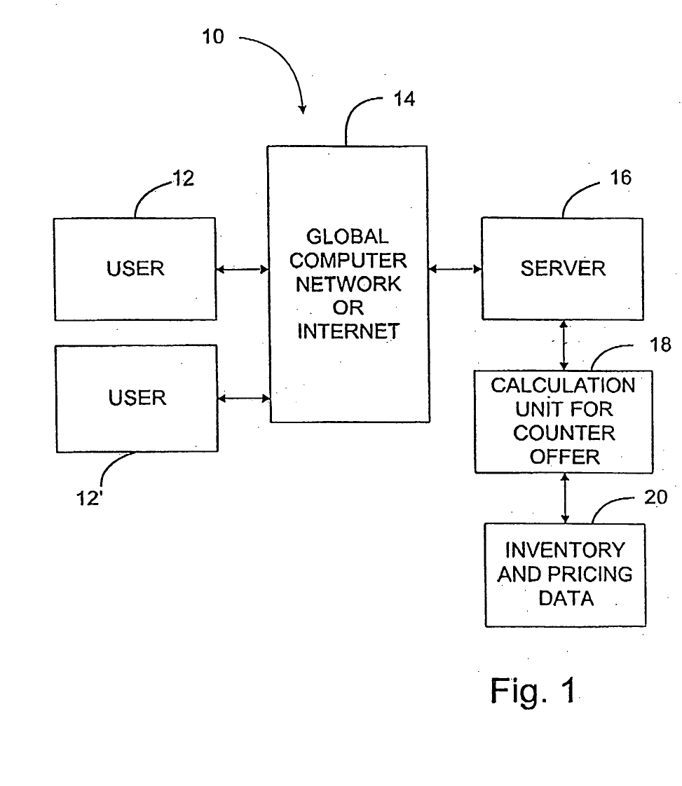

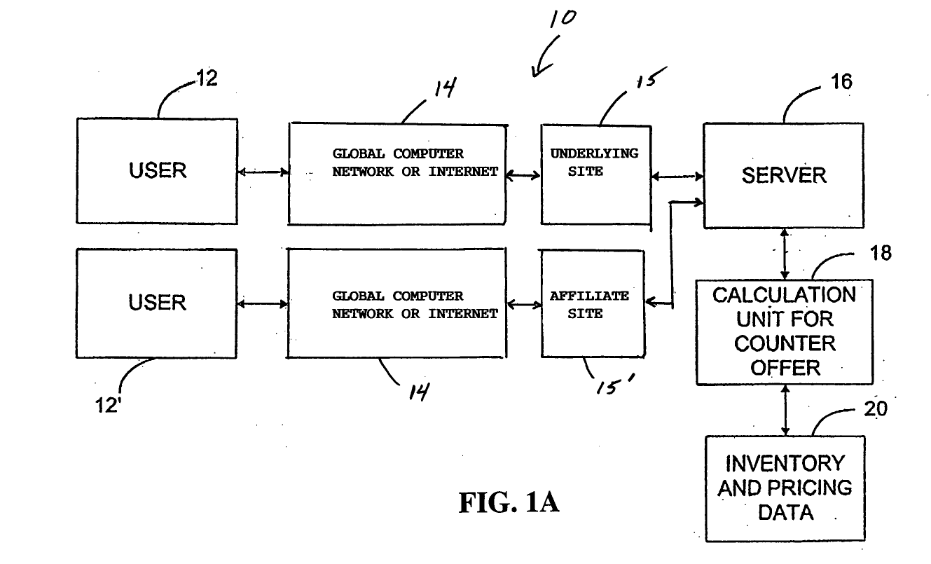

With reference to the appended figures, FIGS. 1 and 1A schematically illustrate an exemplary system 10 according to the present disclosure. With initial reference to FIG. 1, use of the disclosed system by multiple users 12, 12′ is schematically depicted, wherein the multiple users 12, 12′ are electronically connected to a computer network 14, e.g., an intranet, extranet, wireless network, the Internet, the World Wide Web or another computerized network. As shown in FIG. 1, the manner in which the users 12, 12′ access items available for sale/purchase is non-specific, i.e., the schematic depiction of FIG. 1 encompasses implementations wherein users 12, 12′ access items through a single underlying electronic online marketplace and/or through multiple websites (which may or may not include the underlying electronic online marketplace). FIG. 1A illustrates an implementation of the present disclosure wherein multiple users 12, 12′ access items available for sale/purchase through multiple websites, as described in greater detail below.

Although two users are schematically depicted in FIGS. 1 and 1A, the present disclosure contemplates an infinite number of users accessing the disclosed system/method of the present disclosure (subject to system capacity, as is known to persons skilled in the art). The users may be located in a variety of remote locations, and may be accessing the disclosed system/method in their personal and/or professional capacity, i.e., to satisfy their personal interests or the interests of their employer. The users 12, 12′ may access computer network through any suitable electronic device, e.g., a personal computer, laptop computer, personal digital assistant, wireless communication device, e.g., a telephone or cellular phone, or the like.

The computer network 14 is connected to or communicates with one or more servers or processors 16 that is adapted to operate system programming according to the present disclosure. In the case of system user 12, communication with processor 16 takes place through direct interaction with an underlying website 15, i.e., a website managed and/or hosted by an individual/entity that is responsible for the listing of relevant goods and/or services for sale/purchase. System user 12′ communicates with processor 16 by way of an affiliate website 15′, i.e., a website that provides access to the items that are available for sale/purchase based on the listing activities of underlying website 15. Although FIG. 1A depicts only a single affiliate site, it is to be understood that a plurality of affiliate websites may simultaneously interact with processor 16. Similarly, it is to be understood that a multiplicity of users may simultaneously access the “transactional engine” of the present disclosure through underlying website 15 and through the affiliate website(s) 15′, thereby providing significant traffic with respect to the good/services available for purchase/sale and substantially enhancing the leverage of the underlying website 15 in terms of its listing activities.

As used herein, the term “transactional engine” refers to the processor(s) and associated programming/algorithm(s) that support offer-related communications with a potential purchaser of a good or service that is listed by or through the underlying electronic online marketplace of the present disclosure. Thus, as used herein and in response to an offer received from a system user, a “transactional engine” according to the present disclosure may be programmed to advantageously provide multiple counter-offers to such system user. The “transactional engine” may be hosted by underlying website 15 (as schematically depicted in FIG. 1A) or may be hosted by a third party, e.g., an application service provider.

Thus, with further reference to FIG. 1A, according to an exemplary embodiment of the present disclosure, goods/services may be available for purchase for a predetermined duration (e.g., an hour, day, week, unlimited, etc.) though a transactable listing that appears on the underlying electronic online marketplace (i.e., the “listing” service) and one or more affiliate sites. e.g., affiliate partner site(s). The transactable listing that appears at the affiliate site(s) advantageously includes relevant transactional information, e.g., real time statistics such as time remaining, quantity remaining, selling methodology (or methodologies), current price, last price, photo, and/or description. Such transactable listing is automatically retrieved from database(s) associated with the underlying electronic online marketplace and displayed for viewing at the affiliate site(s), e.g., in a predetermined region of the screen layout. In addition, the transactable listing that appears at an affiliate site advantageously includes functionality that automatically links to the transaction page for such transactable item, e.g., at the underlying electronic online marketplace or at an associated back-end site/system.

In a further exemplary embodiment, a user's selection of a transactable listing at an affiliate site 15′ automatically transfers or links such user to the underlying electronic online marketplace. Thus, in such exemplary embodiment, the transactable listing functions, at least in part, as a navigational link to the underlying electronic online marketplace, and the user (once transferred to the underlying electronic online marketplace) is provided with access to and utility of all functionalities associated with the underlying electronic online marketplace. Such functionalities may include variable purchase/pricing modalities, as described in greater detail below. Other features and functionalities associated with exemplary embodiments of the underlying electronic online marketplace will be apparent to persons skilled in the art from the detailed description herein.

According to preferred embodiments of the present disclosure, the goods/services may be available for purchase at an affiliate site (or at the underlying electronic online marketplace) for a limited duration that is preset by the entity making the goods/services available for purchase or by the underlying electronic online marketplace. In the latter circumstance, the limited duration may be automatically determined by processor 16 and the associated programming based on one or more parameters associated with the listing, e.g., the price/commission to be paid to the underlying electronic online marketplace, the number of items listed by the seller, the available inventory, historical sales trends, and the like. In addition, according to exemplary embodiments of the present disclosure, all affiliate sites that display a transactable item are automatically linked into inventory management module/functionality associated with the underlying electronic online marketplace, such that sales of goods/services by users of the affiliate site are automatically reflected in available inventory levels. Moreover, in the event that counter-offers to be provided potential purchasers of goods/services are based, at least in part, on available inventory levels, such information is available for calculation of an appropriate counter-offer, as described in greater detail herein below.

The listings that are displayed at affiliate sites according to the present disclosure are not simply advertisements, but are complete transactable listings that may be advantageously supported by comprehensive inventory management, multiple selling methodologies and/or a specific limited life duration. As noted above, the transactional functionality may be advantageously supported at the affiliate site, or by linking a user to the underlying electronic online marketplace where such functionality may be provided. The noted parameters may be entered or set up by the seller through predetermined criteria at an underlying electronic online marketplace site, e.g., based on menu driven data entry forms and/or data entry templates. Each listing links to an associated good/service that is specifically listed on the underlying electronic online marketplace for immediate transactability. The transactional functionality associated with the disclosed system and method is distinctly different from currently available methodologies, e.g., the advertisement-based links associated with commercial websites (e.g., Google), wherein ads are simply linked to disparate locations selected by advertisers. According to such commercially available systems, the links are not tied to an underlying electronic online marketplace, as described herein, nor do the links permit simultaneous access to goods/services from multiple websites, wherein such goods/services are subject to limited transactable lifetime(s) and/or specific transactable selling methodologies (as specified by the seller at the underlying electronic online marketplace), as described herein.

By way of example and with further reference to FIG. 1A, when a user/customer (e.g., user 12) seeks to list an item or plurality of items (e.g., goods or services) for sale according to the present disclosure, he/she will access an electronic online marketplace site 15 across a computer network, e.g., the Internet. Through appropriate data entry tools, e.g., an online form, drop-down menu, or the like, he/she may be advantageously given an opportunity to select to have his/her item appear on other sites for a specific fee. The fee may take many forms, e.g., cost per click, a one time fixed price, or a share of commissions, as will be apparent to persons skilled in the art. Thus, depending on the fee structure made available to users/customers by underlying electronic online marketplace 15, the user/customer may be subject to a first pricing mode if an item is sold to a user who accesses the item at the underlying electronic online marketplace 15, and a second, higher pricing mode if the item is sold to a user that accesses the item from an affiliate site 15′.

To facilitate automatic display of a listed transactable item at appropriate affiliate website(s), certain information concerning the listed item is advantageously solicited and collected when the item is initially listed for sale/purchase. Exemplary criteria that are useful in automatically identifying appropriate affiliate website(s) include one or more specific product/service categories and/or one or more keywords. Such criteria may be selected from a list of available categories/keywords, or may be entered by the listing individual for subsequent use/synthesis by the system/method of the present disclosure. The specific information collected when the item is listed for sale/purchase (e.g., categories and/or keywords) typically act as a trigger for display of the item at an affiliate website. Other triggers according to exemplary embodiments of the present disclosure may include payment/commission levels associated with listed items (with the items that are likely to generate the highest financial return for the underlying electronic online marketplace receiving greater trigger priority), and/or the ending time/date for sale of a particular listing (with the items closest to expiration receiving greater trigger priority).

According to exemplary embodiments of the present disclosure, a triggering system is typically programmed into processor 16. According to an exemplary triggering system, an affiliate site 15′ typically requests a transactable item from processor 16 for display at the affiliate site. After validating the affiliate site 15′ (i.e., confirming that affiliate site 15′ has properly registered with the underlying electronic online marketplace through password or other validation functionality), the processor 15′ automatically determines relevant information concerning the affiliate site 15′ (e.g., based on information previously provided to the underlying electronic online marketplace that may be contained in an associated database or information that is provided to the processor as part of the request for a transactable listing). Based on the triggering system associated with processor 16, the processor automatically determines the transactable listing(s) to be provided to the affiliate system for real time display at such affiliate site. As noted above, multiple triggers may be employed and, where multiple triggers are simultaneously considered, a weighting algorithm may be provided to facilitate selection from among transactable listings available for real time display.

The affiliate website(s) 15′ that elect to display transactable listings typically are compensated for display of such transactable items at the affiliate site, for sale of a transactable item to a user that accesses the transactable item from such affiliate site 15′, are based on other financial criteria, as will be readily apparent to persons skilled in the art. The affiliate site 15′ is typically required to load a module of code (or other programming) on their website to facilitate real time communication with processor 16. The code/programming is also typically designed to capture appropriate log information, thereby supporting advantageous reporting functionalities that facilitate management objectives and financial reconciliations between the affiliate website 15′ and the underlying electronic online marketplace 15. Additional functionalities, content management tools and formatting/layout parameters may be associated with the module/code loaded at affiliate website 15′, as will be apparent to persons skilled in the art.

Of note, an affiliate website 15′ is typically provided with several options for choosing which types of items may be accessed from processor 16 for display at its site. In particular, the affiliate website 15′ may also be advantageously provided with the ability to select specific trigger criteria for controlling automatic selection of transactable items for retrieval from processor 16. For example, the trigger criteria selected by an affiliate website 15′ may be selected from a group that includes one or more specific product/service categories and/or one or more specific keywords. Alternatively, the underlying electronic online marketplace 15 and its associated processor 16 may be provided with spider technology that automatically determines from viewing the affiliate site 15′ appropriate triggers to be associated with such affiliate website 15′, e.g., appropriate keywords and/or categories for transactable items that could be advantageously displayed at such affiliate website.

According to a further embodiment of the present disclosure, transactable items for display at an affiliate site 15′ may be governed, in whole or in part, by a randomization factor. Such randomization factor may be automatically generated by processor 16, and may be used either alone or in conjunction with other triggers (e.g., financial considerations, keywords, categories, expiration time, etc.) to determine the transactable item(s) to be communicated to an affiliate site 15′ for display in real time.

According to exemplary embodiments of the present disclosure, the trigger criteria selected by an affiliate site 15′ can be simple or complex. For example, an affiliate site 15′ might desire only transactable items that include the keywords “Titleist” and/or “golf”, but exclude any items with the keyword “ball”. Thus, in such circumstance, the triggers will be effective in retrieving from the database(s) associated with processor 16 items that include the keywords “Titleist” and “driver”, “Titleist” and “iron”, and “Titleist” and “putter”. However, through the selection of a negative trigger (i.e., keyword “ball”), the affiliate site 15′ would not retrieve for display any transactable “golf ball” listings. Specific trigger criteria for a given affiliate website is typically associated with the code module/programming placed on the affiliate website, thereby permitting individual affiliate websites to establish unique trigger criteria that meet its strategic/tactical marketing/sales/positioning objectives. Such criteria may typically be changed and/or refined at the election of the affiliate website from time-to-time, thereby permitting adjustments based on experience, sales/marketing/positioning initiatives, or other factors, as will be readily apparent to persons skilled in the art.

According to the present disclosure, one or more of the following four (4) features may be incorporated into exemplary implementations of the disclosed systems and/or methods. Although the four features described herein below may be combined, in whole or in part, as may be desired based on the teachings herein and the advantages associated therewith, a preferred embodiment of the present disclosure incorporates each of the four features described herein below.
1) The information associated with transactable items that are displayed at affiliate sites may be provided with real time information, e.g., an ending date and time (either in absolute terms or in relative terms (e.g., “4 hours and 56 minutes”)). This real time information concerning the transactable item is supplied by processor 16 for display at affiliate website 15′.
2) The transactable items that are displayed at an affiliate site may include a display (or other indication) of available transaction types, such as the “Make an Offer” automated negotiation system (discussed below), auction, and/or instant purchase. For example a transactable item displayed at an affiliate site might be displayed with verbiage that says “Make an Offer Now! Bids and Instant purchase also available for this item.” In some instances, to save on space, graphical icons representing these various selling methodologies may be used in place of the wording (in whole or in part).
3) Transactable items may optionally be displayed with information reflecting the current bid, instant purchase price and/or last offer for this specific item. This additional real time information (which is communicated from processor 16 to the applicable affiliate websites) for simultaneous display at multiple websites fosters enhanced transactional interest and highly relevant data for purposes of potential purchasing decisions by system users/customers.
4) Transactable items may be displayed at affiliate website(s) with other beneficial real time information, e.g., quantities remaining for Bid, “Make an Offer” and/or Instant purchase.

Returning to FIGS. 1 and 1A, according to an exemplary embodiment of the present disclosure, a calculation unit 18 is typically associated with server/processor 16, i.e., processing functionality that operates to perform calculations as described herein. Calculation unit 18 is particularly adapted for accessing offer(s) received across the network, e.g., from users 12, 12′, determining whether the offer(s) are acceptable based on predetermined criteria and, to the extent the offer(s) fail to satisfy the predetermined criteria, generating one or more counter offers for transmission to such user(s) and/or communicating as to next steps/time frame for continuing/resuming the negotiation process. According to exemplary embodiments of the present disclosure, calculation unit 18 calculates one or more acceptable pricing formulations that are incorporated into counter offers, such pricing formulations generally reflecting one or more advantageous price/quantity combinations.

The counter offers, which incorporate the proposed pricing formulation(s), are generated based on predetermined negotiation system criteria and/or predetermined values stored in data storage unit 20 that is associated with the server/processor 16. For purposes of the present disclosure, the terms “predetermined negotiation system criteria” and “predetermined criteria” refer to algorithmic systems, formulae, databases and/or data tables that are pre-selected or predefined by a system user or by the system itself, and are then accessed and/or run by a server or processor to determine, calculate or generate acceptable business terms for a potential transaction, e.g., acceptable combinations of price and quantity. Data storage 20 generally stores information and/or data that constitutes and/or is relevant to calculating the predetermined criteria according to the negotiation system/method of the present disclosure, e.g., inventory and pricing data on different products and services available to users of the disclosed system 10. Of note, however, the calculation unit advantageously communicates with a source of “real time” or periodically updated data for use in generating counteroffers, e.g., current inventory levels and the like.

According to exemplary embodiments of the present disclosure, calculation unit 18 may be used to calculate or generate a plurality of counter offers to be provided to a user 12, 12′ based upon predetermined negotiation system criteria. In the predetermined negotiation system criteria, different price breaks or prices may be set for a predetermined or predefined number of units. The price breaks or pricing may also be determined by a predetermined percentage of a starting cost based upon the number of units. Thus, the price breaks and/or pricing may be calculated and/or generated based upon a variety of parameters, and such parameters may be inter-related in a variety of ways, as will be apparent to persons skilled in the art based on the present disclosure.

Additionally, different counter offers may be generated for each offer that is made and received by the disclosed server/processor. This variability may be achieved by incorporating a randomization factor into the process of determining, calculating and/or generating counter offers. The randomization factor may be determined/incorporated into the counter offer process in a variety of ways. For example, a randomized counter offer may be generated/calculated by predefining a predetermined price for the number of units requested and adjusting it by a randomly determined amount. In an exemplary embodiment, the randomized adjustment may range from zero to a predetermined counter offer adjustment range or amount (up to 100%) of the predetermined price for the specified units.

All aspects of the randomization factor and its calculation by the disclosed system/method may be advantageously set/determined by users/administrators of the system/method. As a result, a slightly different price, varying by a maximum of the predetermined counter offer range, may be provided to different users making identical offers, or to a user that provides the same offer more than once.

Thus, exemplary embodiments of the disclosed system/method facilitate negotiations with potential consumer(s), in real time, based on an algorithm that takes into account predetermined price breaks for a product and/or service, coupled with a quantity acceptable for each price break. These price breaks may be fixed dollar amounts or a various percentage above a fixed cost. There is no limit to the number of price breaks set nor the range between breaks.

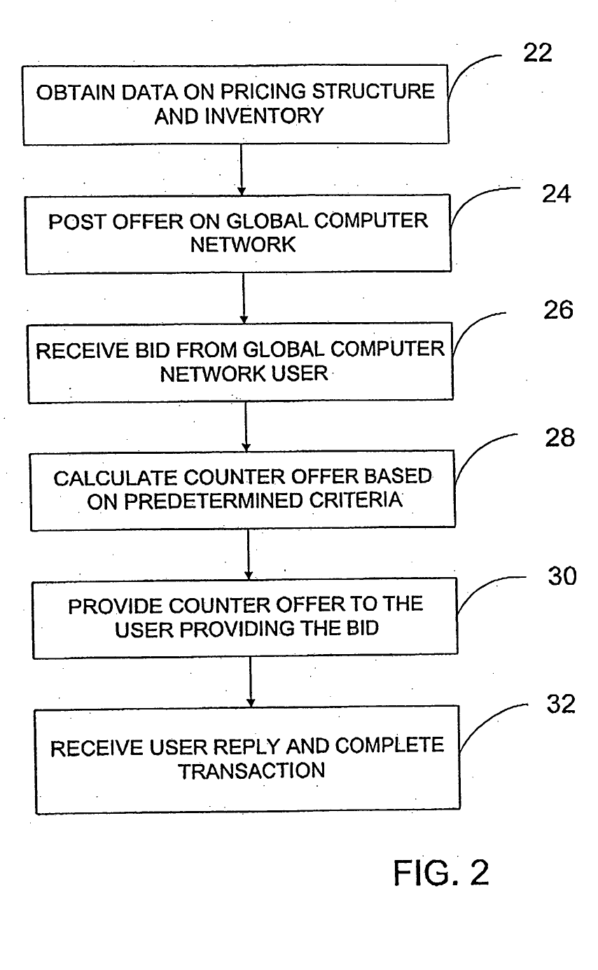

FIG. 2 is a block diagram illustrating certain method steps associated with exemplary embodiments of the present disclosure. Block 22 represents the step of obtaining data on factors and/or data relevant to the negotiation system, e.g., pricing structure and available inventory. Block 24 represents the step of posting an offer to sell a product or service on a computer network, e.g., an intranet, the Internet, etc. Block 26 represents the step of receiving an offer from a user across or via the computer network. For an offer that is deemed unacceptable, block 28 represents the step of calculating one or more counter offers based on the price or quantity requested by a user and predetermined criteria associated with the disclosed system/method. Thus, factors and/or data, such as inventory data (as then-contained in data base storage or as obtained in from an appropriate source in “real time”) and predefined negotiation criteria, are utilized to generate/calculate appropriate counter offer(s) pursuant to the disclosed system/method. Block 30 represents the step of providing or communicating a counter offer to a user in response to the offer initially received from such user. Block 32 represents the step of repeating the offer-counter offer cycle or completing a transaction should the counter offer be accepted by the user.

To further describe the disclosed system and method, several exemplary embodiments and examples, which further elucidate illustrative implementations of the disclosed automated negotiation process, are described herein below. It is to be understood, however, that the following implementations and examples are merely illustrative of the disclosed system/method, and that the disclosed system/method is not limited thereto.

According to a first exemplary implementation, the predetermined criteria are set such that, if an offer falls below one of the predetermined price breaks that would be deemed acceptable by applicable acceptance criteria, then three counter offers will be presented to the buyer, as follows:
1. If the price falls within one of the price breaks, but the quantity requested is below the quantity preset for that price break, the disclosed system/method automatically notifies the potential buyer that his/her offer is not accepted, but that the price offered will be accepted so long as the buyer agrees to purchase the quantity preset for the price break by the seller, i.e., within the predetermined criteria.
2. As an alternative or second counter offer to #1 above, the disclosed system/method automatically finds the price break within which the quantity requested by the buyer falls. The system/method then takes this price break dollar amount and multiplies it by a random number generated by the server/processor and multiplies this product by a range set by the seller, i.e., set within the predetermined criteria. This figure is then added to the original price break dollar amount producing a counter offer which is presented/communicated to the buyer for the number of units requested.
3. As an additional option to the buyer, if #1 or #2 are not acceptable to the buyer, option #3 simply allows the buyer to buy the unit immediately for a fixed price set by the seller, i.e., within the predetermined criteria. This “Buy Now” feature is advantageously part of every offer/counter offer.
   According to exemplary embodiments of the present disclosure, a potential buyer of a product or service can only make an offer at predetermined intervals set by the buyer, i.e. once every twenty four (24) hours, once every forty eight (48) hours, once during the life of the offer, or any other interval the seller chooses.

The seller of a product or service is generally provided with the ability to set the following variables/parameters which initialize system for a given product or service.
1) Price breaks and quantities acceptable for each price break:
These price breaks may also be represented in a starting cost and percentage increments which will produce fixed price breaks from this data.
2) The “wait period” duration, which the buyer has to wait to make a repeated/follow-up offer on the same product/service:
This can be any duration, but common values will be in the twenty four (24) hour to life of the offer range. The system may advantageously check several aspects of a buyer's personal data to verify and/or determine if he/she has already made an offer within the predefined repeat offer duration period.
3) The counter offer range which is used to calculate the counter offer made by the system:
The counter offer range may be from 0 to infinity, although more common or preferred values will be in the 0.05 to 0.2 range. A separate counter offer range may, and generally is, set for each price break, or the range can be the same, whichever the seller chooses in predefining the relevant predetermined criteria.
4) The quantity available for sale, i.e., for which potential buyers may submit offers according to the disclosed system/method:
This quantity is automatically reduced for each offer accepted and/or purchase made.
5) The “Buy Now” price which the buyer can accept at any time:
The Buy Now price is generally included in the predetermined criteria by the seller.

The following table illustrates an exemplary relationship between fixed price and # of unit breaks which may be set by the seller, i.e., within the predetermined criteria. According to the present disclosure, there is no limit to the number of price breaks that may be set or defined within the predetermined criteria.

TABLE 1

| Price Break | # units | Counter Offer Range |
|---|---|---|
| 5.00 | 12 | .10 |
| 6.00 | 8 | .10 |
| 7.00 | 6 | .10 |
| 8.00 | 4 | .10 |
| 9.00 | 2 | .10 |
| 10.00 | 1 | .10 |

Additional information that may be advantageously included in the predetermined criteria, i.e., beyond the type of information set forth in Table 1, include:
The wait period duration for repeat offers: 24 hours
Global Counter Offer Range (used if not set on a per level basis)—0.10
# of units Available—100 units
Buy Now Price: $19.99

According to the present disclosure, price breaks may also be determined by a starting cost and percentage breaks. For example, the following exemplary percentages may be used, which equate to the following price break chart (Starting Cost: $5.00):

TABLE 2

| Percentage | Creates this Price Break | # units (set by seller) |
|---|---|---|
| 0 | 5.00 | 12 |
| .2 ($5.00 × 1.2) | 6.00 | 8 |
| .3 ($5.00 × 1.3) | 6.50 | 6 |
| .4 ($5.00 × 1.4) | 7.00 | 4 |
| .5 ($5.00 × 1.5) | 7.50 | 2 |
| .6 ($5.00 × 1.6) | 8.00 | 1 |

The duration, counter offer range for each level, the global counter offer range, the # of units available, and buy now price may also be set or predefined as part of the predetermined criteria, as discussed above.

Additional exemplary implementations of the disclosed system/method are set forth below, with reference in certain circumstances to the above-noted tables.

### EXAMPLE #1

Buyer offers $12.50 for one (1) unit of whatever product or service is being offered in Table 1.

Result: Offer is accepted and buyer is notified.

### EXAMPLE #2

Buyer offers $8.35 for four (4) units of whatever product or service is being offered in Table 1.

Result: Offer is accepted and buyer is notified.

### EXAMPLE #3

Buyer offers $8.50 for two (2) units of whatever product or service is being offered in Table 1.

Result: Three (3) counter offers are presented:
1. Price will be accepted if buyer can take four (4) units.
2. A price generated by our negotiation system will be offered to the buyer for the two (2) units requested.
3. The “Buy Now” price of $19.99 is also offered as an option to the buyer. Of note, the buyer may also be notified that he/she can try again, i.e., make an additional/follow-up offer, after the applicable (e.g., twenty four (24) hour) repeat offer duration period has expired.

### EXAMPLE #4

Buyer offers $6.75 for 200 units of whatever product or service is being offered in Table 1.

Result: Two (2) counter offers are presented (and the Buy Now option):
1. Price will be accepted if buyer can take the remaining 100 units on hand. Since there are only 100 units left, that is all that is offered to the buyer.
2. Since the number of units requested exceed the lowest price break quantity, there is no 2^{nd} option presented in this case.
3. The “Buy Now” price of $19.99 is also offered as an option to the buyer Of note, the buyer may also be notified that he/she can try again, i.e., make an additional/follow-up offer, after the applicable (e.g., twenty four (24) hour) repeat offer duration period has expired.

### EXAMPLE #5

Buyer offers $4.00 for one (1) unit of whatever product or service is being offered in Table 1.

Result: Two (2) counter offers are presented (and the Buy Now option).
1. Since the price falls below the minimum price break for one (1) unit, this counter offer is not presented at all in this case.
2. A price generated by the disclosed negotiation system/method will be offered to the buyer for the one (1) unit requested.
3. The “Buy Now” price of $19.99 is also offered as an option to the buyer Of note, the buyer may also be notified that he/she can try again, i.e., make an additional/follow-up offer, after the applicable (e.g., twenty four (24) hour) repeat offer duration period has expired.

### EXAMPLE #6

### Example of Calculating Counter Offer(s)

Assumptions:

1) Offer made is $7.50;
2) Quantity requested is four (4) units;
3) Random Number generated is 0.57;
4) “PriceBreakDollarAmount” is $8.00; and
5) Counter Offer Range for this level is 0.10
   Formula:
(PriceBreakDollarAmount*RandomNumber*Range)+PriceBreakDollarAmount ($8.00*0.57*0.10)+$8.00=$8.456 is counter offer for four (4) units

In this example #6, an exemplary method/formula for using predefined negotiation criteria to calculate a counter offer is illustrated according to the disclosed system/method. In this embodiment, a random number is used between 0.00 and 1.00 to calculate a counter offer that is within a predetermined range, in this example 10% of a predetermined dollar amount. In this example, the counter offer for four (4) units having a price break dollar amount of $8.00 will range randomly between $8.00 and $8.80, depending upon the randomly generated number between 0.00 and 1.00 multiplied by the range of 10%.

### EXAMPLE 7

### Working Internet-Based Example

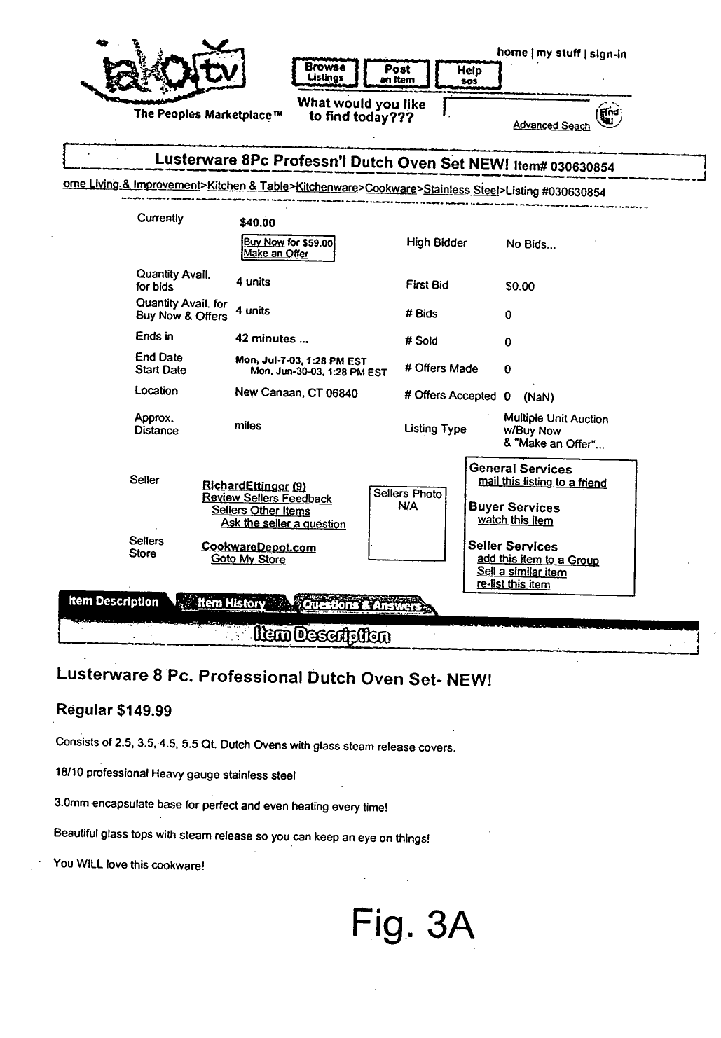

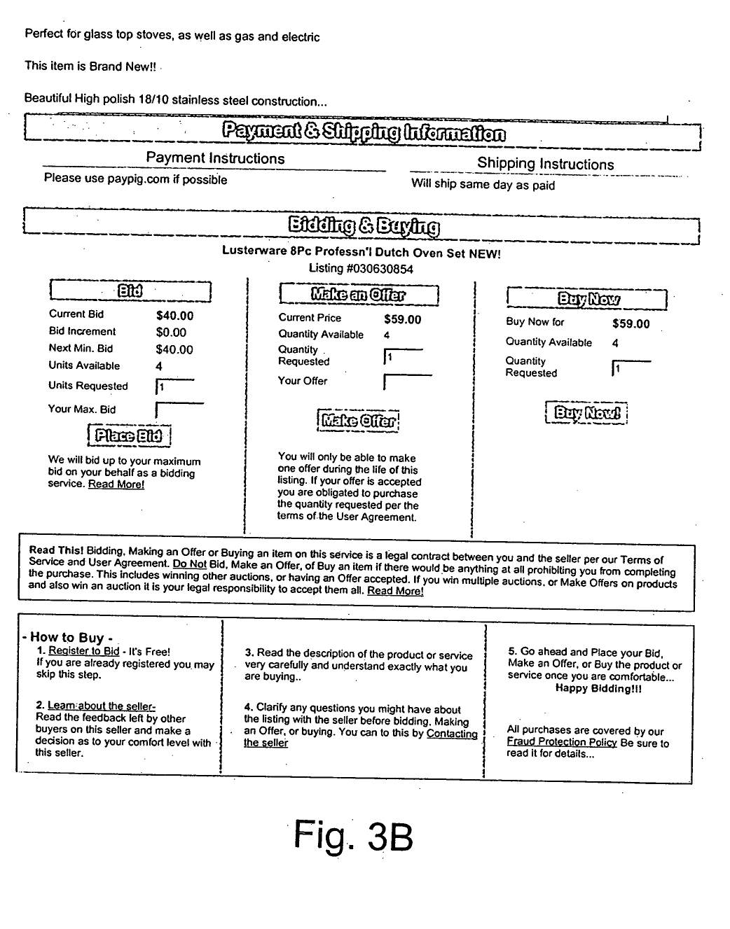

With reference to FIGS. 3-9, a Lusterware 8 piece professional Dutch oven cookware set was listed for sale at a website supporting Internet-based sales transactions. In making the cookware set available for sale, the system of the present disclosure was employed on the back-end to evaluate and respond to offer(s) received in response to the sales listing. The parameters selected according to the disclosed system were as follows:

| Price | Quantity | Counter Offer Range |
|---|---|---|
| $50.00 | 1 unit | 10% |
| $45.00 | 2 units | 10% |
| $40.00 | 4 units | 10% |

The total number of units available was set at four (4). The wait period was set for twenty four (24) hours. The “Buy Now” price was set at $59.00. Information associated with the preset parameters according to the system of the present disclosure are set forth in the screen shot of FIGS. 3A and 3B.

Information concerning the cookware set was made available for viewing on a webpage 300, as shown in the screen shots of FIGS. 3A and 3B. With particular reference to FIG. 3B, the “Make an Offer” block 302 and “Buy Now” block 304 are directly associated with the subject matter of the present disclosure. Thus, in the Make an Offer block 302 shown on FIG. 3B, a current price of $59.00 (which corresponded to and was derived from the Buy Now price defined herein above) and the Quantity Available (four) were displayed. In addition, webpage 300 provided the potential purchaser with two (2) input boxes within Make an Offer block 302, namely “Quantity Requested” box 306 and “Your Offer” box 308. Upon entering values into boxes 306, 308, the potential purchaser submitted the offer for consideration by clicking on the “Make Offer” box 310.

Alternatively, the potential purchaser was free to purchase the cookware set at the Buy Now price of $59.00 by entering the desired quantity in the “Quantity Requested” box 312 within Buy Now block 304. Upon entering the desired quantity, the order could be submitted by clicking on the “Buy Now” box 314.

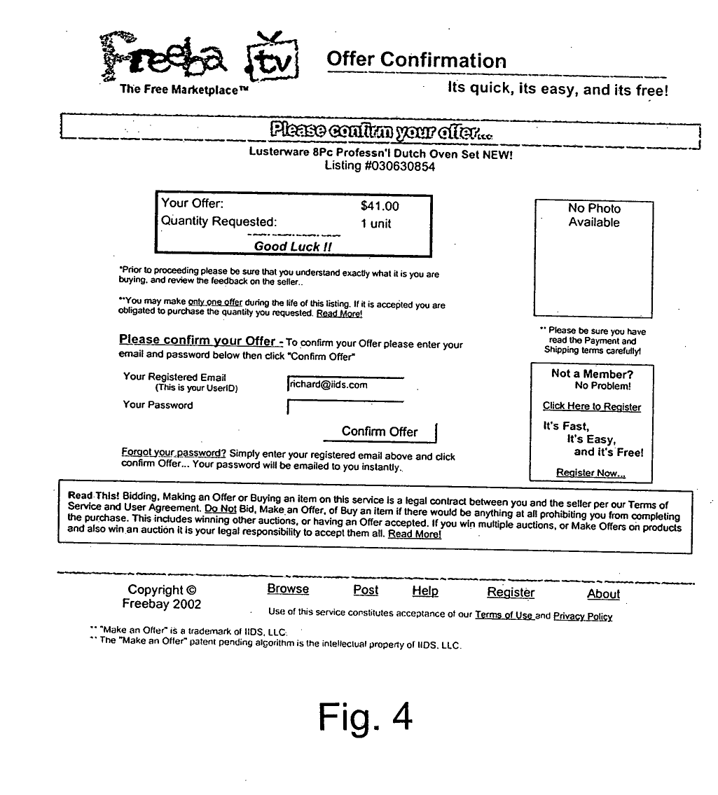

According to the present disclosure and with reference to FIG. 4, a first offer of $41.00 for one (1) unit was submitted to the system by a potential purchaser. Offer confirmation 200 is shown in FIG. 4. The system of the present disclosure automatically evaluated the first offer in terms of price and quantity, and determined that such offer did not satisfy the predetermined price ($50.00) for a quantity of one.

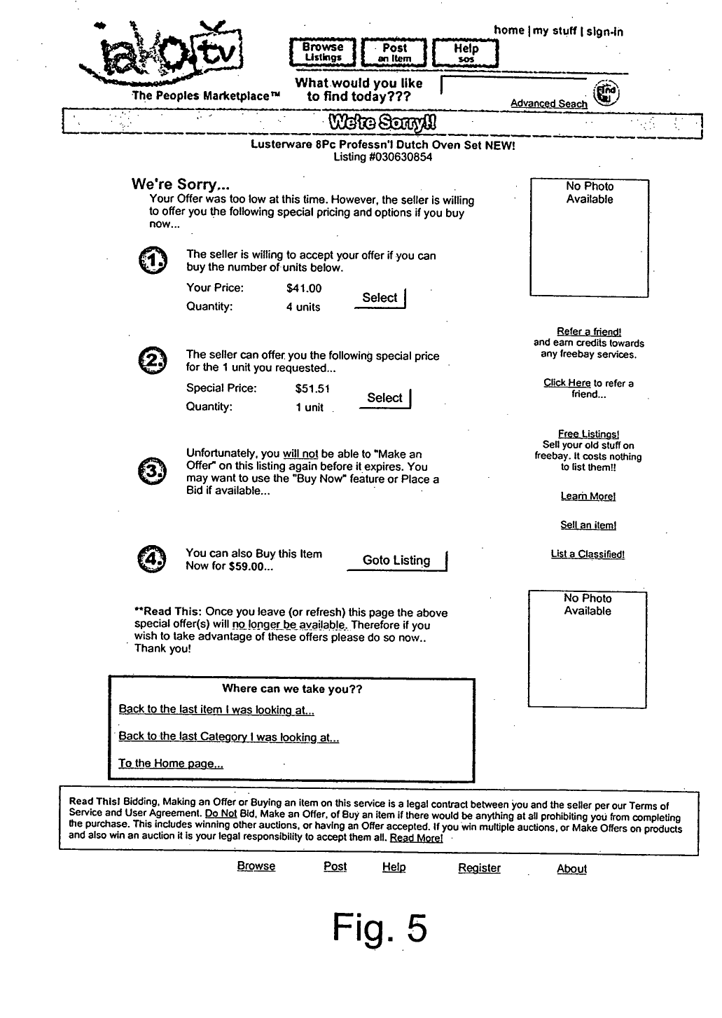

Based on such evaluation, the system of the present disclosure rejected the first offer and automatically provided a four-point responsive communication to the potential purchaser, as shown in screen shot 500 of FIG. 5. In particular, the disclosed system generated a first counter-offer at the price proposed by the potential purchaser, i.e., $41.00. Based on the pre-set parameters set forth above, the system determined that a price of $41.00 exceeded the threshold price for a quantity of four (i.e., $40.00), and therefore the first counter-offer 502 proposed four units at a price of $41.00.

Alternatively, the second counter-offer was based on the requested quantity of one and was again based on the pre-set parameters set forth above. The system automatically determined that a price of $50.00 (with a counter offer range of 10%) was acceptable for a single cookware set and, based on the randomization factor, arrived at the second counter-offer 504 of one unit for $51.51.

The third point of communication apprised the potential purchaser of the temporal limitation on his/her use of the Make an Offer function. Thus, as set forth in communication block 506, the potential purchaser was advised that additional Make an Offer submissions would not be possible within the prescribed timeframe, based on the pre-set temporal parameter set forth above.

Finally, the fourth communication box 508 reiterated the Buy Now option available to the potential purchaser at the Buy Now price of $59.00.

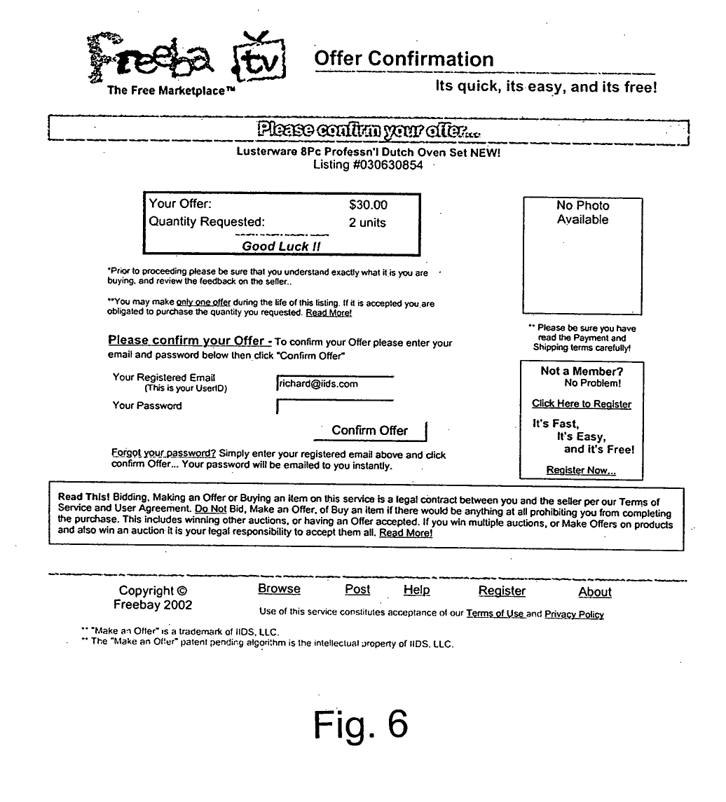

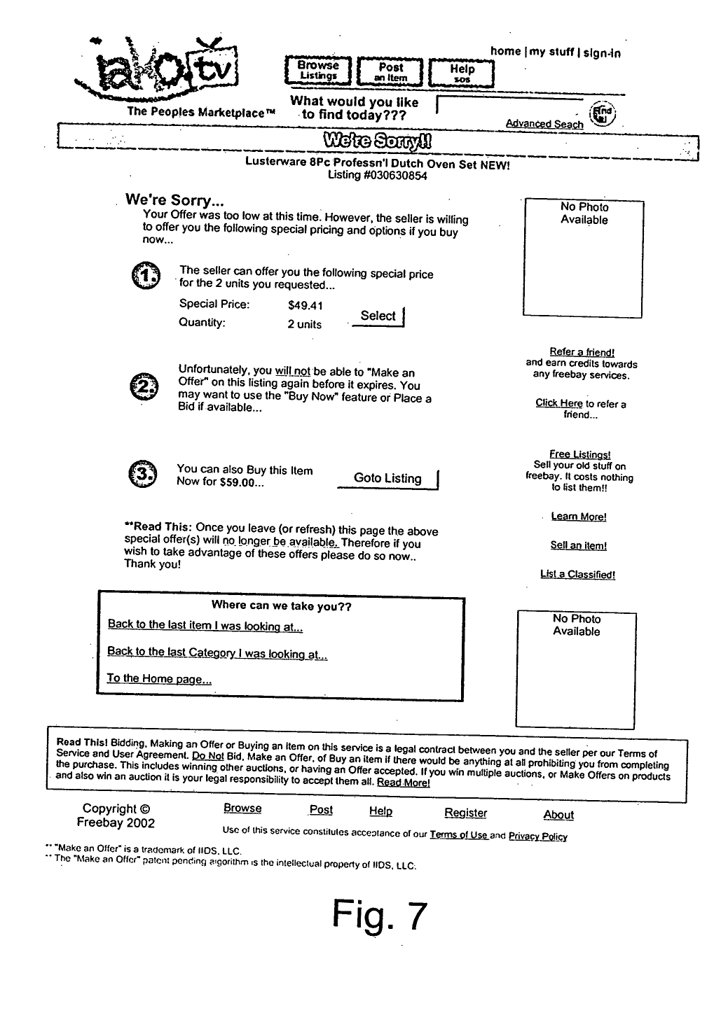

With reference to screen shot 600 of FIG. 6, a second offer was made for the Lusterware 8 piece professional Dutch oven cookware set as follows: 2 units for $30.00 each. In response and as shown in screen shot 700 of FIG. 7, the system of the present disclosure automatically rejected the second offer, but responded with a three point communication. In the first counter offer 702, the potential purchaser was offered an alternative price for the quantity requested (i.e., two units), based on the pre-set parameters set forth above. Thus, the first counter offer 702 was based on the pre-set price of $45.00 for two units (with a counter offer range of 10%), and was extended at a price of $49.41 (based on a randomization factor).

A counter-offer was not extended at the price proposed by the potential purchaser (i.e., $30.00 per unit) because the pre-set parameters did not extend as low as $30.00 (the lowest price was set at $40.00). Thus, the second communication box 704 provided temporal information and the third communication box 706 reiterated the Buy Now option available to the potential purchaser at the Buy Now price of $59.00.

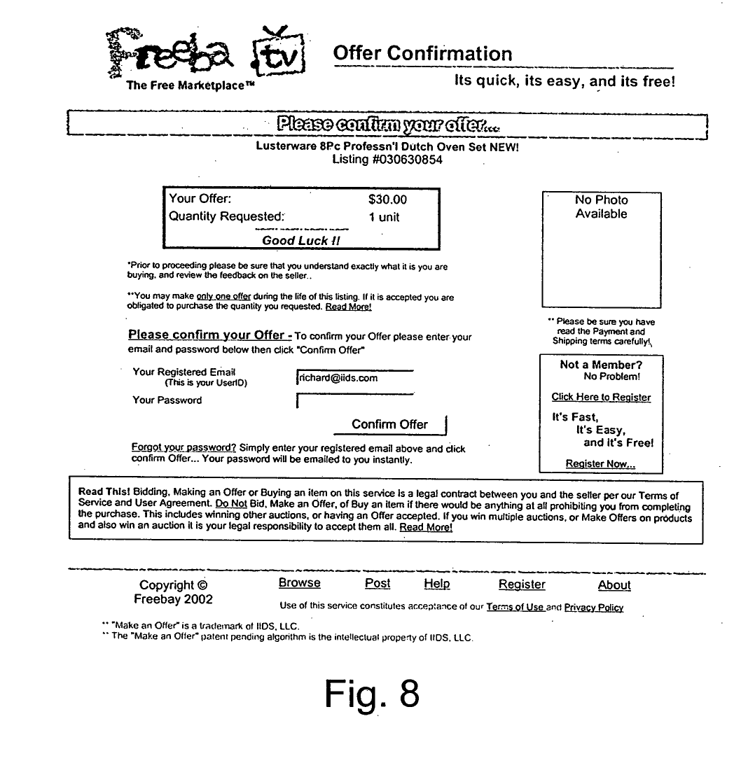

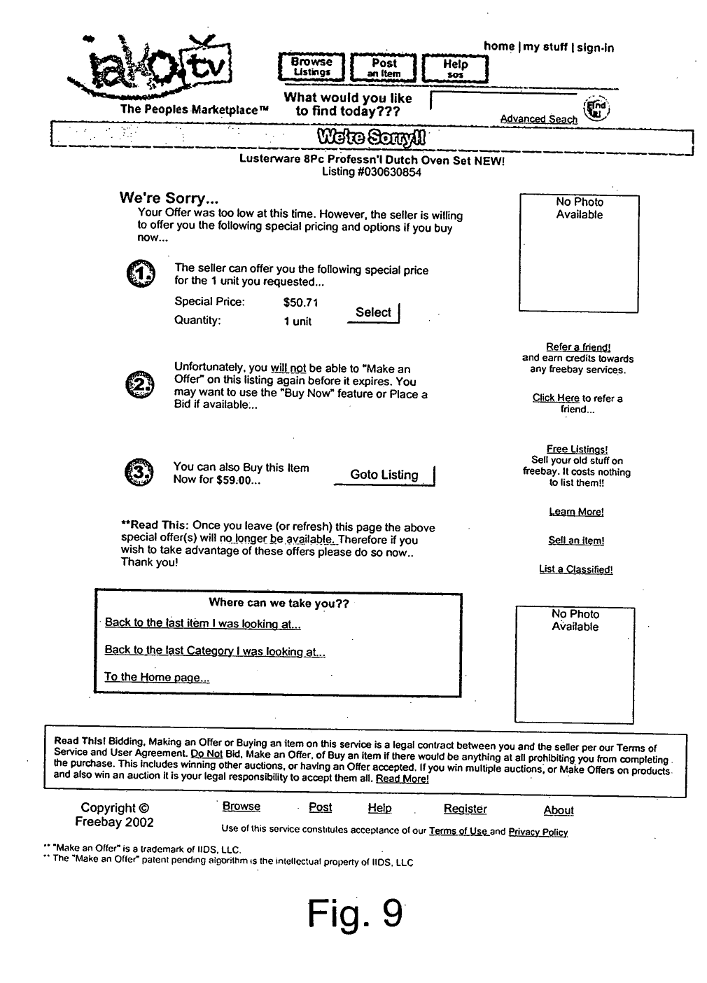

With reference to screen shot 800 of FIG. 8, a third offer was made for the Lusterware 8 piece professional Dutch oven cookware set as follows: 1 unit at $30.00. In response and as shown in screen shot 900 of FIG. 9, the system of the present disclosure automatically rejected the third offer, but responded with a three point communication. In the first counter offer 902, the potential purchaser was offered an alternative price for the quantity requested (i.e., one unit), based on the pre-set parameters set forth above. Thus, the first counter offer 902 was based on the pre-set price of $50.00 for one unit (with a counter offer range of 10%), and was extended at a price of $50.71 (based on a randomization factor).

As with the second offer, a counter-offer was not extended for the third offer at the price proposed by the potential purchaser (i.e., $30.00 per unit) because the pre-set parameters did not extend as low as $30.00 (the lowest price was set at $40.00). Thus, the second communication box 904 provided temporal information and the third communication box 906 reiterated the Buy Now option available to the potential purchaser at the Buy Now price of $59.00.

### EXAMPLE 8

### Second Working Internet-Based Example

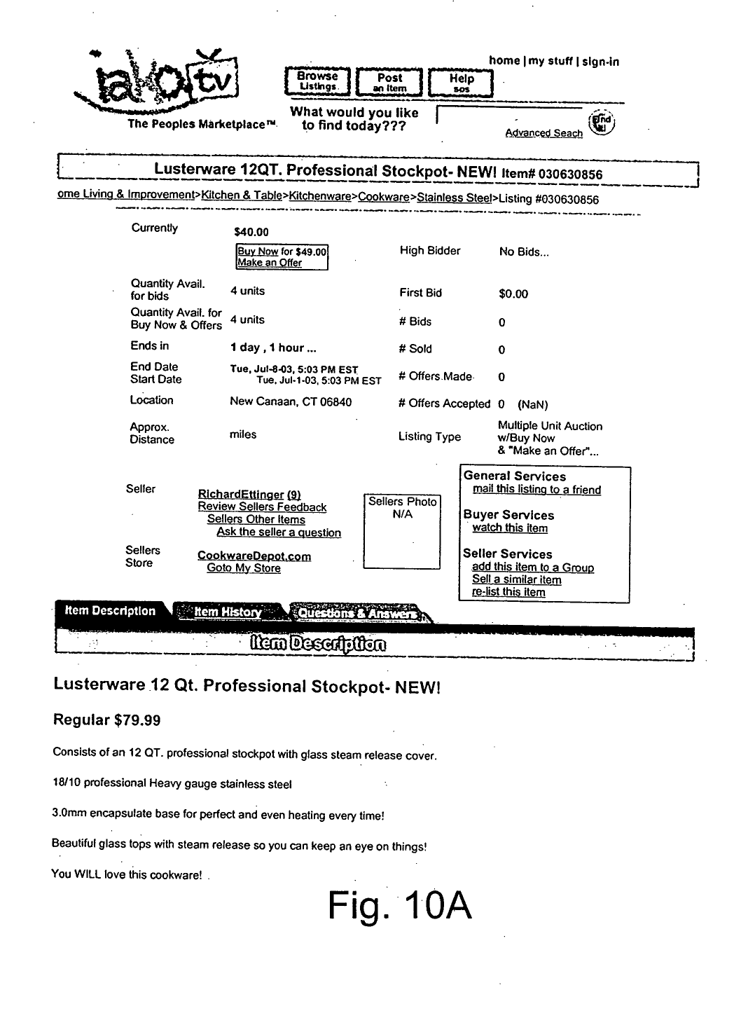

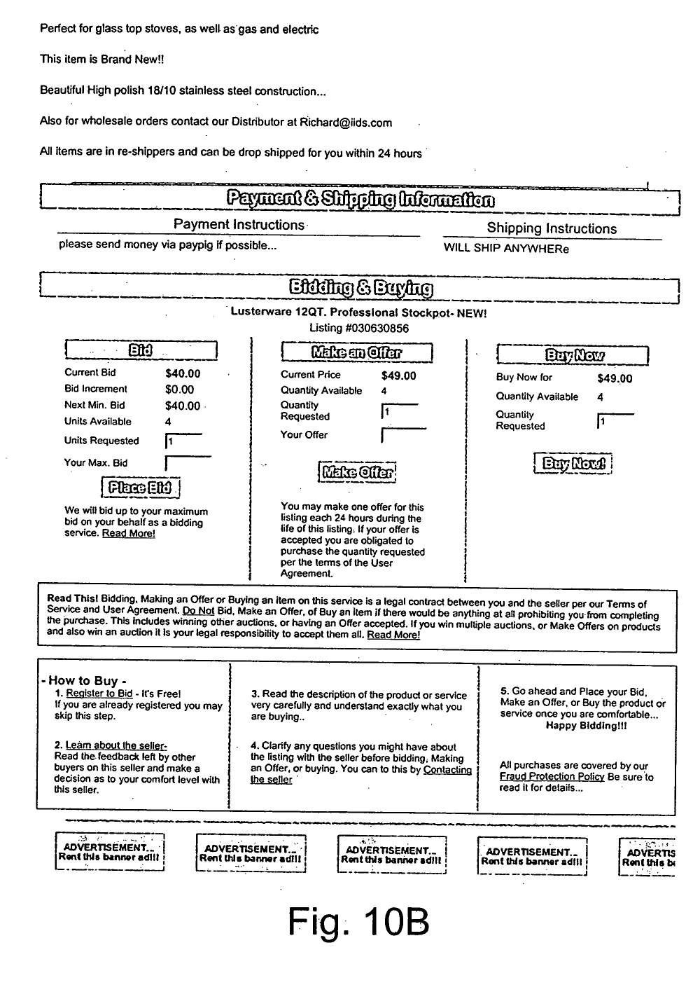

With reference to FIGS. 10-16, a Lusterware 12 quart professional stockpot was listed for sale at a website supporting Internet-based sales transactions. In making the stockpot available for sale, the system of the present disclosure was employed on the back-end to evaluate and respond to offer(s) received in response to the sales listing. The parameters selected according to the disclosed system were as follows:

| Price | Quantity | Counter Offer Range |
|---|---|---|
| $45.00 | 1 unit | 10% |
| $40.00 | 2 units | 10% |
| $36.00 | 4 units | 10% |

The total number of units available was set at four (4). The wait period was set for twenty four (24) hours. The “Buy Now” price was set at $49.00. Information associated with the preset parameters according to the system of the present disclosure are set forth in the screen shot of FIGS. 10A and 10B.

Information concerning the stockpot was made available for viewing on a webpage 1000, as shown in the screen shots of FIGS. 10A and 10B. With particular reference to FIG. 10B, the “Make an Offer” block 1002 and “Buy Now” block 304 are directly associated with the subject matter of the present disclosure, and are identical in design and function to the blocks described with reference to FIG. 3B, which description is incorporated herein by reference.

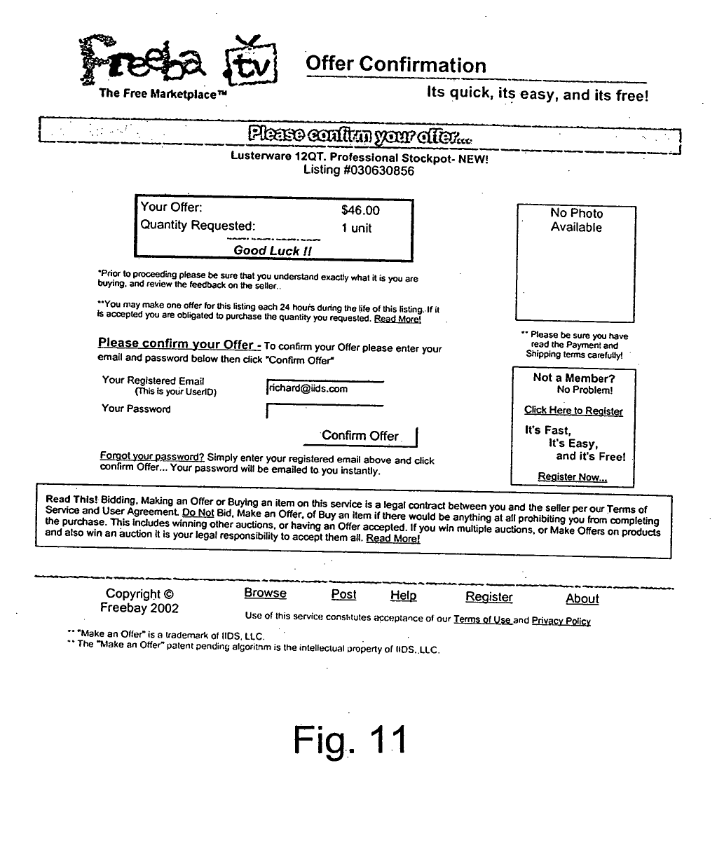

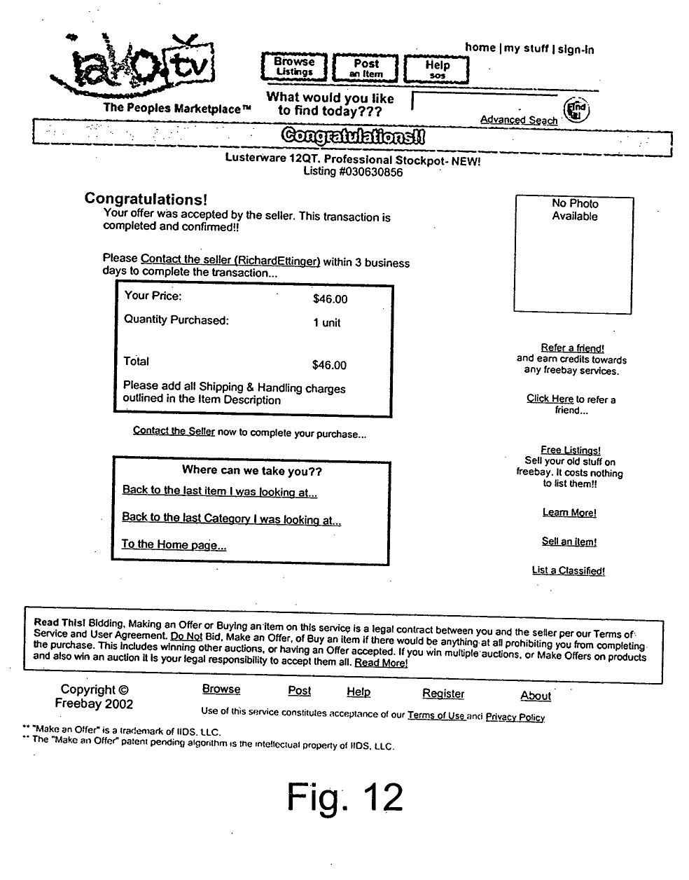

According to the present disclosure and with reference to FIG. 11, a first offer of $46.00 for one (1) unit was submitted to the system by a potential purchaser. Offer confirmation 1100 is shown in FIG. 11. The system of the present disclosure automatically evaluated the first offer in terms of price and quantity, and determined that such offer satisfied the predetermined price ($45.00) for a quantity of one. Thus, as shown in screen shot 1200 of FIG. 12, the first offer was automatically accepted by the system of the present disclosure, and the purchaser was provided with guidance as to obtaining the purchased item.

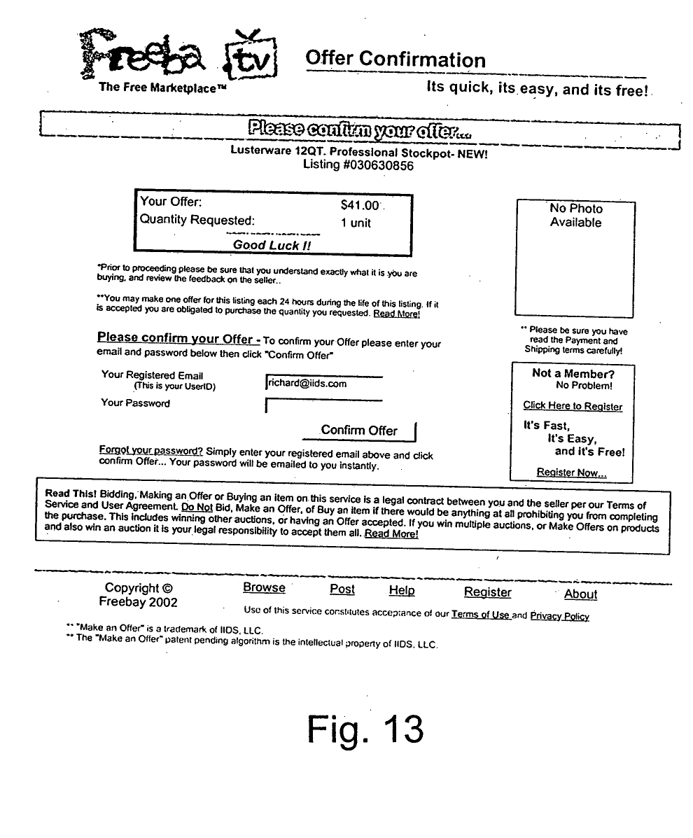

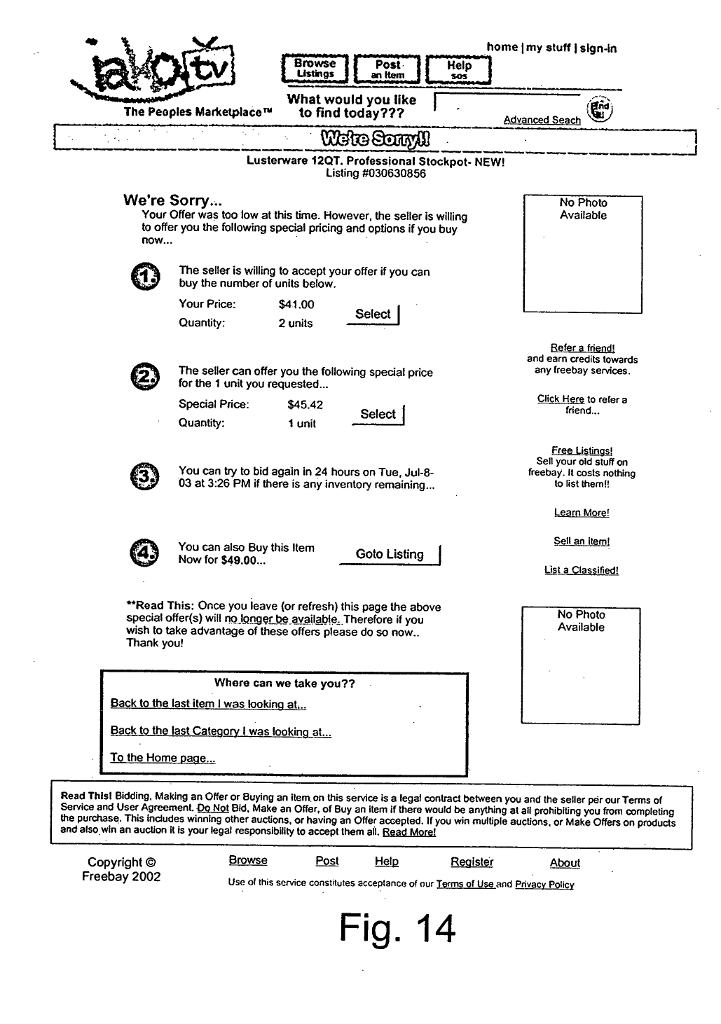

With reference to screen shot 1300 of FIG. 13, a second offer was made for the Lusterware 12 quart stockpot as follows: 1 unit for $41.00. In response and as shown in screen shot 1400 of FIG. 14, the system of the present disclosure automatically rejected the second offer, but responded with a four point communication. In the first counter offer 1402, the potential purchaser was offered an alternative quantity for the price requested ($41.00), based on the pre-set parameters set forth above. Thus, since the first counter offer 1402 exceeded the threshold price of $40.00 for two units, the first counter offer 1402 was extended at a price of $41.00 for two units.

Alternatively, the second counter-offer was based on the requested quantity of one and was again based on the pre-set parameters set forth above. The system automatically determined that a price of $45.00 (with a counter offer range of 10%) was acceptable for a single stockpot and, based on the randomization factor, arrived at the second counter-offer 1404 of one unit for $45.42.

The third communication box 1406 provided temporal information based on the twenty four hour response period included in the pre-set parameters, and the fourth communication box 1408 reiterated the Buy Now option available to the potential purchaser at the Buy Now price of $49.00.

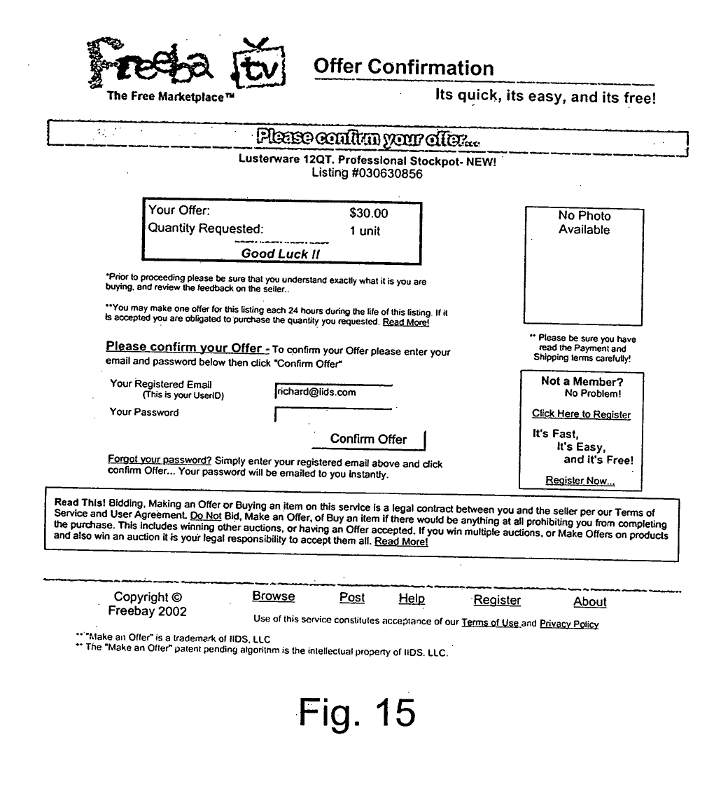

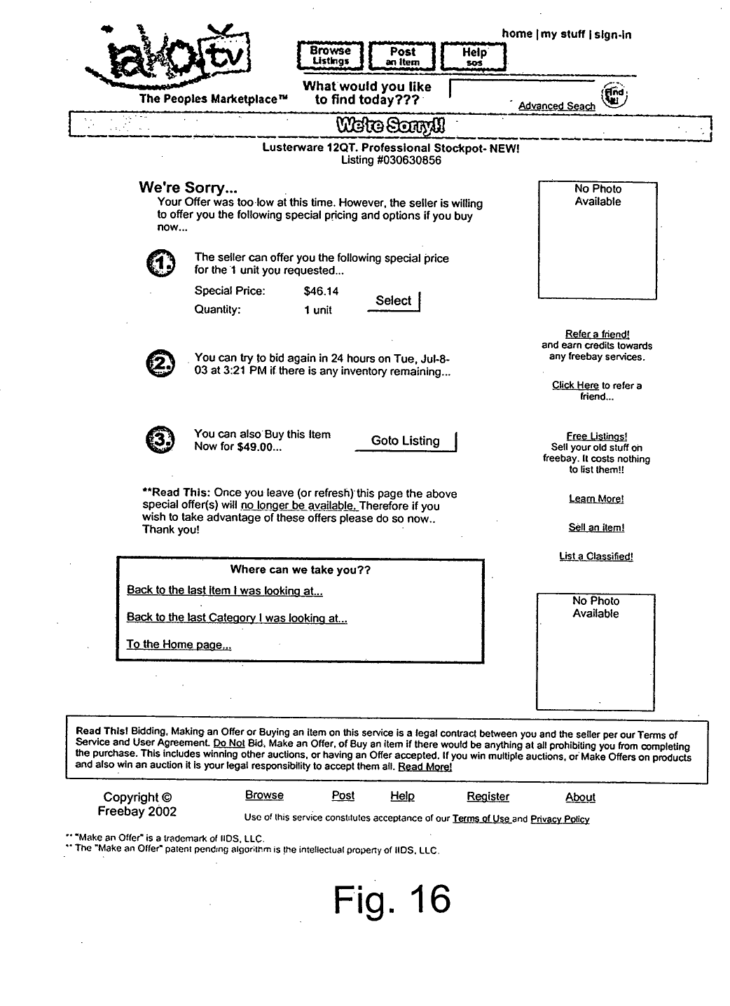

With reference to screen shot 1500 of FIG. 15, a third offer was made for the Lusterware 12 quart stockpot as follows: 1 unit at $30.00. In response and as shown in screen shot 1600 of FIG. 16, the system of the present disclosure automatically rejected the third offer, but responded with a three point communication. In the first counter offer 1602, the potential purchaser was offered an alternative price for the quantity requested (i.e., one unit), based on the pre-set parameters set forth above. Thus, the first counter offer 1602 was based on the pre-set price of $45.00 for one unit (with a counter offer range of 10%), and was extended at a price of $46.14 (based on a randomization factor).

A counter-offer was not extended for the third offer at the price proposed by the potential purchaser (i.e., $30.00 per unit) because the pre-set parameters did not extend as low as $30.00 (the lowest price was set at $36.00). Thus, the second communication box 1604 provides temporal information and the third communication box 1606 reiterated the Buy Now option available to the potential purchaser at the Buy Now price of $49.00.

According to a further exemplary implementation, the predetermined criteria are set such that, if an offer falls below one of the predetermined price breaks that would be deemed acceptable by applicable acceptance criteria, then three counter offers will be presented to the buyer, as follows:
1. If the price falls within one of the price breaks, but the quantity requested is below the quantity preset for that price break, the disclosed system/method automatically notifies the potential buyer that his/her offer is not accepted, but that the price offered will be accepted so long as the buyer agrees to purchase the quantity preset for the price break by the seller, i.e., within the predetermined criteria.
2. As an alternative or second counter offer to #1 above, the disclosed system/method automatically finds the price break value for the quantity requested by the buyer. According to this further exemplary embodiment, the foregoing price break value is utilized as a “lower boundary” in defining a “price break range.” The “upper boundary” for such price break range corresponds to the preset price for the next lower quantity of items. The “next lower quantity” may differ from the quantity requested by a single unit or by some greater differential, e.g., five units, ten units, etc., as may be selected by the seller in establishing desired quantity/price thresholds. For example, if the quantity requested by the buyer is “3” units, the “lower boundary” (which corresponds to the preset price for “3” units) might be $8.00, while the “upper boundary” (which corresponds to the preset price for “2” units or the next-specified unit level) might be $9.00. Thus, according to this further exemplary embodiment, the disclosed system/method calculates the difference between the upper and lower boundaries (i.e., $9.00−$8.00=$1.00) and multiplies such difference by a random number generated by the server/processor. In the case of the highest price break value, a counter offer range, e.g., 10%, 20% or the like, is used to define a price break range. Thus, the highest price break value defines the lower boundary value and is multiplied by the counter offer range percentage to automatically calculate an upper boundary value. For example, if the highest price break value is $10.00 and the counter offer range percentage is 20%, then the upper boundary value would be $12.00 (i.e., 20% larger than $10.00). The counter offer would then be calculated based on the difference between the upper boundary (i.e., $12.00) and the lower boundary value ($10.00), such difference being $2.00. The difference would be multiplied by a random number generated by the server/processor and the resulting product would be added to the lower boundary value to establish a counter offer value which is presented/communicated to the buyer for the number of units requested. The foregoing counter-offer pricing modality is referred to herein as a “boundary-based pricing modality.”
3. As an additional option to the buyer, if #1 or #2 are not acceptable to the buyer, option #3 simply allows the buyer to buy the unit immediately for a fixed price set by the seller, i.e., within the predetermined criteria. According to exemplary embodiments of the present disclosure, this “Buy Now” feature is advantageously part of every offer/counter offer.
   Of note, exemplary embodiments of the present disclosure may advantageously permit sellers to choose from among different counter-offer pricing modalities. Thus, for example, a potential seller may choose from: (i) a first counter-offer pricing modality wherein counter-offer(s) are calculated using a counter offer range percentage for all price break values, and (ii) a second counter-offer pricing modality wherein counter-offer(s) are calculated using upper/lower boundaries defined by adjacent price break values (for all price break values except the highest price break value), i.e., a “boundary-based pricing modality.” In addition, according to the present disclosure a seller may be provided with an opportunity to select or define pre-set counteroffer price(s), i.e., non-variable counteroffer price(s) that would be communicated to a potential buyer in response to a non-acceptable offer. This non-variable counter-offer pricing modality would be offered as an adjunct to at least one of the other pricing modalities set forth herein according to the present disclosure.

A seller may select from among counter offer pricing modalities through entry of a desired selection at an interactive website and communication of such selection across a network, as is known to persons skilled in the art. Alternatively, a default counter offer pricing modality may be associated with an implementation of the disclosed system/method, such default modality being subject to change by a seller, e.g., based on a web-based selection by such seller.

As discussed above with reference to other exemplary embodiments of the present disclosure, a potential buyer of a product or service can only make an offer at predetermined intervals set by the buyer, i.e. once every twenty four (24) hours, once every forty eight (48) hours, once during the life of the offer, or any other interval the seller chooses.

According to the exemplary “boundary-based pricing modality” embodiment described above, the seller of a product or service is generally provided with the ability to set the following variables/parameters which initialize the disclosed system/method for a given product or service.
1. Price breaks and quantities acceptable for each price break:
These price breaks may also be represented in a starting cost and percentage increments which will produce fixed price breaks from this data.
2. The “wait period” duration, which the buyer has to wait to make a repeated/follow-up offer on the same product/service:
This can be any duration, but common values will be in the twenty four (24) hour to life of the offer range. The system may advantageously check several aspects of a buyer's personal data to verify and/or determine if he/she has already made an offer within the predefined repeat offer duration period.
3. The counter offer range which is used to calculate the counter offer made by the system for the highest price break value:
The counter offer range may be from 0 to infinity, although more common or preferred values will be in the 0.05 (5%) to 0.2 (20%) range.
4. The quantity available for sale, i.e., for which potential buyers may submit offers according to the disclosed system/method:
This quantity is automatically reduced for each offer accepted and/or purchase made.
5. The “Buy Now” price which the buyer can accept at any time:
The Buy Now price is generally included in the predetermined criteria by the seller.

The following table illustrates an exemplary relationship between fixed price and # of unit breaks which may be set by the seller in connection with implementation of the disclosed “boundary-based pricing modality,” i.e., within the predetermined criteria. According to the present disclosure, there is no limit to the number of price breaks that may be set or defined within the predetermined criteria.

TABLE 3

| Price Break | # units |
|---|---|
| 5.00 | 12 |
| 6.00 | 8 |
| 7.00 | 6 |
| 8.00 | 4 |
| 9.00 | 2 |
| 10.00 | 1 |

Additional information that may be advantageously included in the predetermined criteria, i.e., beyond the type of information set forth in Table 3, include:
The counter offer range (for use with highest price break value, i.e., $10.00): 0.20
The wait period duration for repeat offers: 24 hours
# of units Available—100 units
Buy Now Price: $19.99

According to the present disclosure, price breaks may also be determined by a starting cost and percentage breaks. For example, the following exemplary percentages may be used, which equate to the following price break chart (Starting Cost: $5.00):

TABLE 4

| Percentage | Creates this Price Break | # units (set by seller) |
|---|---|---|
| 0 | 5.00 | 12 |
| .2 ($5.00 × 1.2) | 6.00 | 8 |
| .3 ($5.00 × 1.3) | 6.50 | 6 |
| .4 ($5.00 × 1.4) | 7.00 | 4 |
| .5 ($5.00 × 1.5) | 7.50 | 2 |
| .6 ($5.00 × 1.6) | 8.00 | 1 |

The counter offer for highest price break value, duration, the # of units available, and Buy Now price may also be set or predefined as part of the predetermined criteria, as discussed above.

The present disclosure thus provides a unique and advantageous system/method for displaying transactable items for sale/purchase at a plurality of sites in real time. The present disclosure further provides a system/method for automating the offer/counter offer process with respect to such transactable items, i.e., the negotiation process. The disclosed system/method may be implemented on a computer network and may be used for the sale of products and/or services. The present disclosure is particularly applicable to the sale of relatively low cost fungible products or services, such as housewares and other items mass-produced items, although the system/method may be used to advantage in virtually any sales context. Although the disclosed system/method has been described with reference to exemplary embodiments, the disclosure is not to be limited to such exemplary embodiments. Rather, the disclosed system/method is susceptible a wide range of applications and variations, without departing from the spirit and scope of the presently disclosed and claimed invention.

1. A system for implementing an automated negotiation process, comprising:
a processor that is adapted to communicate with a network, said processor further communicating with computer storage that contains information concerning a plurality of transactable items and being adapted to run a program that is maintained within said storage, said program adapted to:
i. automatically access trigger criteria associated with a communication from an affiliate website received across said network, said communication seeking data for display at said affiliate website concerning at least one of said plurality of transactable items stored in said computer storage;
ii. identify based on said trigger criteria at least one transactable item from among said plurality of transactable items for display at said affiliate website; and
iii. transmit data to said affiliate website concerning said at least one transactable item for display at said affiliate website in real time.

2. A system according to claim 1, wherein said processor is further programmed to communicate with a transactional engine that is adapted to facilitate a transaction with respect to said at least one transactable item.

3. A system according to claim 1, wherein said process is further programmed to transmit real time information concerning said at least one transactable item to said affiliate website.

4. A system according to claim 3, wherein said real time information is selected from the group consisting of time remaining for a transaction with respect to said at least one transactable item, quantity of transactable items remaining, available selling methodologies with respect to said at least one transactable item, current price, last price, photograph of said at least one transactable item, description of said at least one transactable item, and combinations thereof.

5. A system according to claim 1, wherein said processor is further programmed to determine a limited duration for display of said at least one transactable item.

6. A system according to claim 5, wherein said processor determines said limited duration based on a factor selected from the group consisting of a price or commission to be paid in connection with sale of the at least one transactable item, the number of said transactable items listed by a seller, available inventory of said at least one transactable item, historical sales trends for said transactable items, and combinations thereof.

7. A system according to claim 1, wherein a transactable item is among the plurality of transactable items for transmission to said affiliate site based at least in part on item-specific information supplied to said processor with respect to said transactable item.

8. A system according to claim 7, wherein said item-specific information involves payment of a fee in connection with sale of said transactable item by an affiliate website.

9. A system according to claim 1, wherein said item-specific information is selected from the group consisting of one or more categories, one or more keywords, and combinations thereof.

10. A system according to claim 1, wherein said processor is further programmed to cooperate with spider functionality to determine characteristics of an affiliate website for use in identifying said at least one transactable item for transmission thereto.

11. A system according to claim 1, wherein said trigger criteria include one or more of the following: at least one keyword, at least one category, a payment or commission level associate with sale of said transactable item, the ending time or date for sale of said transactable item, and an inventory level for said transactable item.

12. A system according to claim 1, wherein said processor is further programmed to:
i. automatically assess an offer to purchase a good or service received from a user of the system across said network against predefined acceptance criteria stored in said computer storage,
ii. automatically generate one or more counter offers based on predetermined criteria stored in said computer storage, and
iii. automatically transmit said one or more counter offers across said network to said system user;
wherein said offer to purchase a good or service includes a quantity value, and
wherein said generation of one or more counter offers includes the steps of:
a. identifying a price break value for said quantity value from said predefined acceptance criteria;
b. establishing a price break range based on said price break value;
c. calculating one or more counter offers based, at least in part, on a product of said price break range and a number randomly generated by said processor.

13. A system according to claim 12, wherein said predetermined criteria include at least two modalities for calculating said one or more counter offers.

14. A system according to claim 12, wherein said computer storage contains information related to the quantity of goods or services available for purchase.

15. A system according to claim 14, wherein said information contained in said computer storage is automatically updated to reflect changes to the quantity of goods or services available for purchase.

16. A system according to claim 12, wherein said price break range is established based on either (i) a counter offer range included within said predefined acceptance criteria, (ii) a difference between price break values for different quantities of goods or services, or (iii) a combination thereof.

17. A system according to claim 16, wherein the method for establishing the price break range is selectable by a system user.

18. A method for conducting a computer-based negotiation, comprising:
i. receiving a request for a transactable item from an affiliate site;
ii. automatically accessing trigger criteria associated with said communication from said affiliate site;
ii. identifying based on said trigger criteria at least one transactable item from among a plurality of transactable items for display at said affiliate website; and
iii. transmitting data to said affiliate website concerning said at least one transactable item for display at said affiliate website in real time.

19. A method according to claim 18, further comprising:
i. receiving an offer from a first location across a network at a processor;
ii. automatically assessing the offer against predefined acceptance criteria;
iii. in the event the offer does not satisfy the predefined acceptance criteria, automatically generating one or more counter offers;
iv. automatically transmitting said one or more counter offers across said network to said first location;
wherein said offer includes a quantity value, and wherein said generation of one or more counter offers includes the steps of:
a. identifying a price break value for said quantity value from said predefined acceptance criteria;
b. establishing a price break range based on said price break value;
c. calculating one or more counter offers based, at least in part, on a product of said price break range and a number randomly generated by said processor.
